(19) United States
(12) Patent Application Publication
(10) Pub. No.: US 2014/0359736 A1
(43) Pub. Date: Dec. 4, 2014

(54) DYNAMIC VOICEPRINT AUTHENTICATION

(71) Applicant: DEVICEAUTHORITY, INC., Fremont, CA (US)

(72) Inventors: Talbot Harty, San Francisco, CA (US); Dono Harjanto, Irvine, CA (US)

(73) Assignee: DEVICEAUTHORITY, INC., Fremont, CA (US)

(21) Appl. No.: 14/264,782

(22) Filed: Apr. 29, 2014

Related U.S. Application Data
(60) Provisional application No. 61/787,453, filed on May 31, 2013.

(51) Int. Cl. H04L 29/06; G06F 3/16

(52) U.S. Cl. CPC H04L 63/0861; G06F 3/16
USPC 726/7

(57) ABSTRACT

A dynamic device key that identifies and authenticates a device and its user includes data representing captured sound of the user speaking a disposable pass phrase. The convenient and secure authentication of voice recognition is combined with convenient and secure device authentication by including biometric voice-recognition of the user in the dynamic device key. During registration, the user speaks all elements of a collection from which disposable pass phrases can be composed. The resulting audio signals, representing the user's voice print as modified by background noise introduced by the device and the environment, are used as references for subsequent authentication. During authentication, a dynamic device key challenge specifies a number of device attributes, including pass phrases to be spoken by the device's user. The pass phrases may be selected in a randomized manner from the collection of disposable pass phrases. The responsive dynamic device key includes data representing an audio signal captured through a microphone of the user speaking the disposable pass phrase and may be obscured with a nonce provided in the challenge. The result is very rigorous device and user authentication.

This application claims priority to U.S. Provisional Application 61/787,453, filed May 31, 2013, which is fully incorporated herein by reference.

### BACKGROUND OF THE INVENTION

1. Field of the Invention

The present invention relates generally to network-based computer security and, more specifically, to methods and systems for authenticating a device and a user for computer network security.

2. Description of the Related Art

Device identification through device keys, i.e., though a collection of hardware and system configuration attributes, has proven to be invaluable in recent years to such technologies as security and digital rights management. In security, authentication of a person can be restricted to a limited number of previously authorized devices that are recognized by their device keys. In digital rights management, use of copyrighted or otherwise proprietary subject matter can be similarly restricted to a limited number of previously authorized devices that are recognized by their device keys.

Device keys can also include information provided by the user to identify and authenticate the user. At the center of user identification is the age-old trade-off between security and the convenience of the user. As an example, it may be helpful to consider some of the most popular passwords users use to protect their information and identity. In October 2012, CBS news reported some of the most commonly used passwords, which included “password”, “123456”, and “12345678”. Other popular passwords in 2012 were “abc123”, “qwerty”, “11111”, “trustnol”, and “letmein”. Other than being easy to guess, what these popular passwords have in common is that they are easy to remember and therefore convenient for the user. In addition, since these passwords are known to be popular, they are highly insecure.

More secure authentication requires significantly more effort from the user. For example, creation of personal certificates for public-key infrastructure (PKI) authentication requires several steps, interacting with a certificate authority, and manual importation of the personal certificate into e-mail readers and other software applications. The current state of certificate creation and use is far more complicated than most casual users of computing devices can manage. And yet authentication of even casual uses of devices is increasingly important as people increasingly conduct financial transactions and access copyrighted media using computing devices.

What is needed is a way to identify and authenticate both a device and a user of the device with increased security without also increasing the inconvenience of the user.

### SUMMARY OF THE INVENTION

In accordance with the present invention, a dynamic device key that identifies and authenticates a device and its user includes data representing captured sound of the user speaking a disposable pass phrase. The convenient and secure authentication of voice recognition is combined with convenient and secure device authentication by including biometric voice-recognition of the user in the dynamic device key.

During registration, the user speaks all elements of a collection from which disposable pass phrases can be composed, e.g., a collection of one or more of words, letters, and numbers. Audio signals representing the user speaking each element of the collection is captured at registration of the user and are used as references for subsequent authentication. Additional audio signals representing background noise recorded during the user speaking each element may also be captured as a reference for subsequent authentication.

During authentication, a dynamic device key challenge specifies a number of device attributes, including interactive attributes to be provided by the device's user. At least one of the interactive attributes is a disposable pass phrase consisting of one or more elements selected in a randomized manner from the collection of pass phrase elements. The responsive dynamic device key includes data representing an audio signal captured through a microphone of the user speaking the disposable pass phrase obscured with a nonce provide in the challenge.

The result is very rigorous device and user authentication.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a computing device, a server, and a device authentication server that cooperate to identify and authenticate the device and its user in accordance with one embodiment of the present invention.

FIG. 2 is a transaction flow diagram illustrating the manner in which the device is registered with the device authentication server for subsequent authentication.

FIG. 3 is a transaction flow diagram illustrating the manner in which the user of the device of FIG. 1 is registered with the device authentication server for subsequent authentication in an embodiment in which the device and the user are registered separately.

FIG. 4 is a transaction flow diagram illustrating the manner in which the device, the server, and the device authentication server of FIG. 1 cooperate to authenticate the device and the user of the device.

FIG. 5 is a block diagram of a known device record used by the device authentication server to authenticate the device.

FIG. 6 is a block diagram of attribute value record that stores data representing respective audio signals of the user speaking each element of the collection of pass phrase elements.

FIG. 7 is a logic flow diagram of a hierarchical authentication process by which the device authentication server authenticates the device and user.

FIG. 8 is a logic flow diagram illustrating the capture of audio signals of the user speaking the elements of the collection of pass phrase elements.

FIG. 9 is a logic flow diagram of an illustrative example of comparison logic for comparison of an audio signal of the user speaking the disposable pass phrase to the reference audio signals of FIG. 6.

FIG. 10 is a block diagram showing in greater detail the server of FIG. 1.

FIG. 11 is a block diagram showing in greater detail the device authentication server of FIG. 1.

FIG. 12 is a block diagram showing in greater detail the device of FIG. 1.

### DETAILED DESCRIPTION

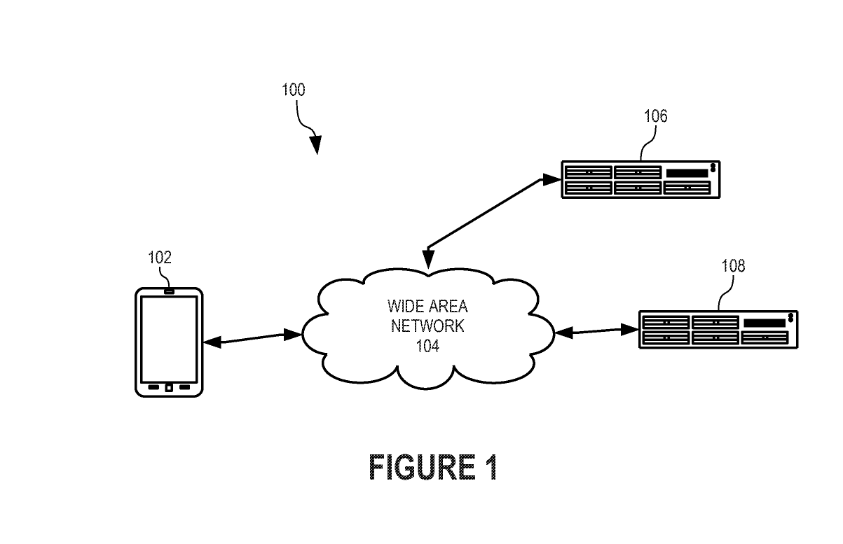

In accordance with the present invention, a device authentication server 108 (FIG. 1) authenticates a computing device 102 and a user thereof using a variety of types of hardware and system configuration attributes of device 102 and interactive attributes provided by the user, including biometric attributes in the form of a recorded voice of the user. The biometric attribute includes captured sound of the user speaking a disposable pass phrase. The disposable pass phrase consists of a number of elements of speech, a complete set of which are recorded from the user during voice registration. In this illustrative embodiment, the elements are words. In an alternative illustrative embodiment, the elements are alphanumeric characters such as letters and numbers.

Device authentication system 100 includes device 102, a server 106, and device authentication server 108 that are connected to one another through a wide area computer network 104, which is the Internet in this illustrative embodiment. Device 102 can be any of a number of types of networked computing devices, including smart phones, tablets, netbook computers, laptop computers, and desktop computers. Server 106 is a server that provides services to remotely located devices such as device 102 but that is configured to require authentication of device 102 prior to providing those services. Device authentication server 108 is a server that authenticates devices, sometimes on behalf of other computers such as server 106.

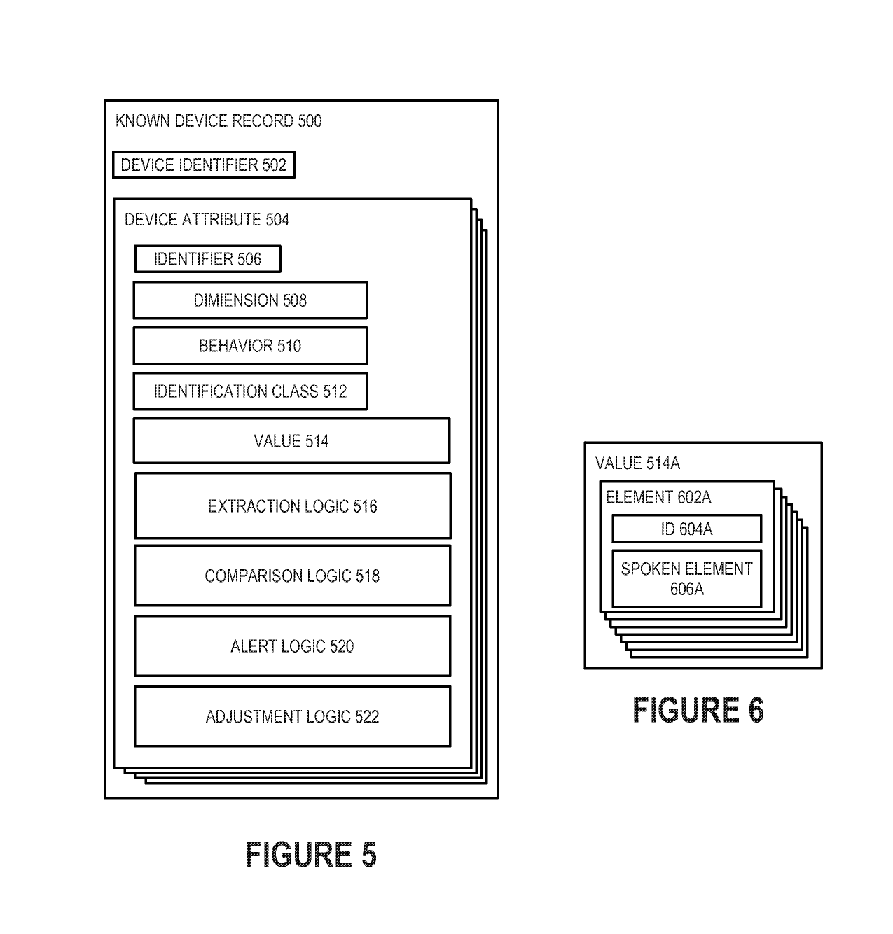

Device attributes are described briefly to facilitate understanding and appreciation of the present invention. Known device record 500 (FIG. 5) includes device attributes 504, both of which are described in greater detail below. Each device attribute 504 includes an identifier 506 and a value 514. Examples of device attributes of device 102 include a serial number of a storage device within device 102 and detailed version information regarding an operating system executing within device 102. In the example of a serial number of a storage device, identifier 706 specifies the serial number of a given storage device (such as “C:” or “/dev/sda1”) as the particular information to be stored as value 514, and value 514 stores the serial number of the given storage device of device 102.

In this illustrative embodiment, device attributes are categorized according to physical, environment, and interactive dimensions. Those dimensions are described in co-pending U.S. Patent Application 61/694,612 for “Adaptive Device Identification” filed on Aug. 29, 2012 and that description is incorporated herein by reference.

Device attributes of the interactive dimension are provided by the user and therefore identify and authenticate the user of device 102 rather than device 102 itself. In this illustrative embodiment, at least one of the interactive attributes is captured sound of the user speaking pass phrase elements that collectively form a disposable pass phrase.

In the disposable pass phrase, the pass phrase itself does not provide an authentication factor. Instead, the user's voice provides a biometric factor of authentication. The disposable pass phrase, by being different for each act of authentication, avoids repeated use of the same voice sounds for authentication across multiple authentication events. As a result, surreptitious capture and re-use of the user's recorded voice to spoof authentication is particularly difficult. For example, if the pass phrase challenge asks the user to say “bravo charlie delta” and another with malicious intent intercepts the recorded sound, such recorded sound cannot be used to spoof authentication if the subsequent challenge is different, e.g., “x-ray echo golf”.

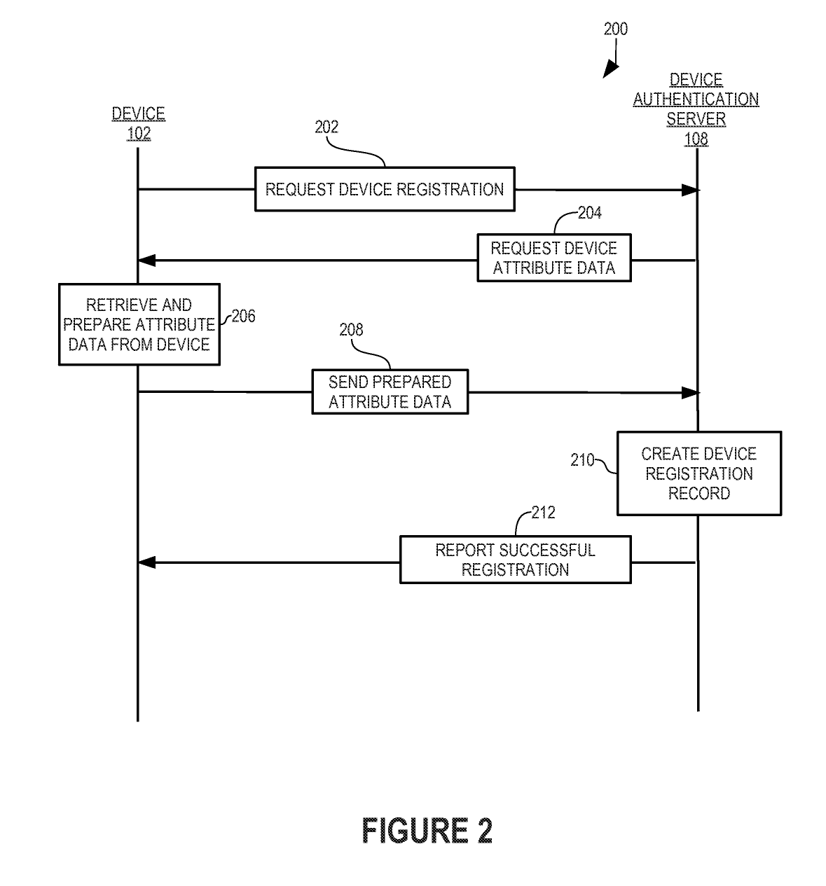

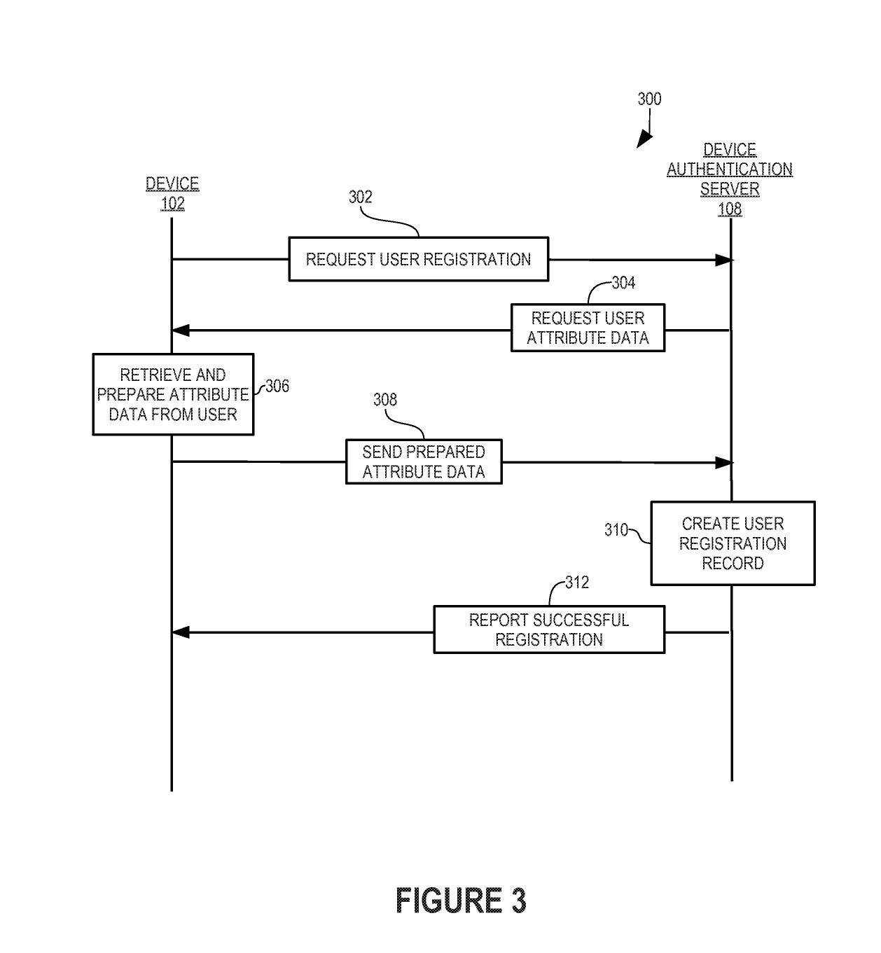

For subsequent authentication of the user, registration in the manner illustrated in transaction flow diagrams 200 (FIG. 2) and 300 (FIG. 3) retrieves sound samples of the user speaking each of the elements that can be subsequently included in a disposable pass phrase.

The sound samples retrieved may also include background noise that is characteristic of the particular audio capturing and transmission system, and may include ambient noise in the user's environment. In this sense, the background noise may be a physical or an environmental device attribute, or a combination of both. In one implementation, as an enhanced security measure, ambient or artificial background noise may be intentionally introduced during registration when recording the pass phrases.

Transaction flow diagram 200 (FIG. 2) represents the manner in which device 102 registers itself with device authentication server 108 such that device 102 can subsequently be authenticated.

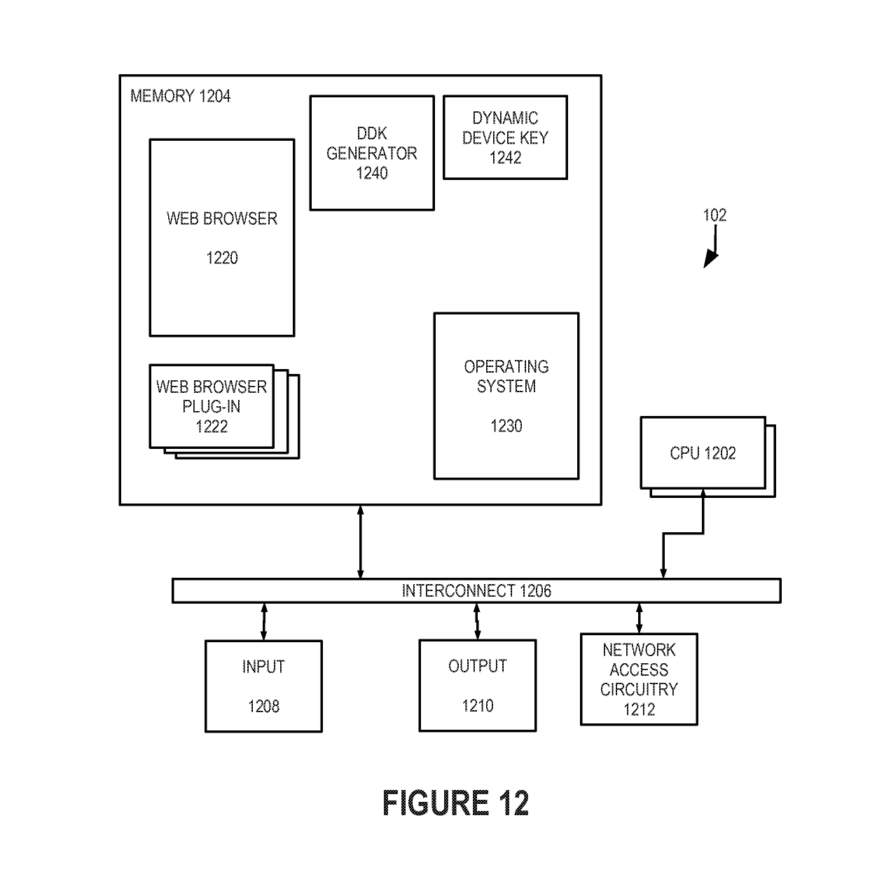

In step 202, device 102 sends a request for registration to device authentication server 108. The request can be in the form of a URL specified by the user of device 102 using a web browser 1220 (FIG. 12) executing in device 102 and conventional user interface techniques involving physical manipulation of user input devices 1208. Web browser 1220 and user input devices 1208 and other components of device 102 are described in greater detail below.

In step 204 (FIG. 2), device authentication server 108 sends a request to device 102 for device attributes of device 102.

The request sent to device 102 includes content that causes web browser 1220 (FIG. 12) of device 102 to gather attribute data representing hardware and other configuration attributes of device 102. In one embodiment, a web browser plug-in 1222 is installed in device 102 and, invoked by web browser 1220, processes the content of the web page to gather the attribute data in step 206. In other embodiments, the attribute data can be gathered by other forms of logic of device 102, such as dynamic device key (DDK) generator 1240 installed in device 102. The various elements of device 102 and their interaction are described more completely below.

The content that causes web browser 1220 (FIG. 12) of device 102 to gather attribute data representing hardware and other configuration attributes of device 102 includes extraction logic 516 (FIG. 5) for each of the attributes web browser 1220 (FIG. 12) is to gather. In an alternative embodiment, DDK generator 1240 already includes extraction logic for all attributes and device 102 receives data identifying the particular attributes requested by device authentication server 108. Extraction logic 516 (FIG. 5) defines the manner in which a client device is to extract data to be stored as value 514 of device attribute 504.

In this illustrative embodiment, web browser plug-in 1222 (FIG. 12) or DDK generator 1240 encrypts the attribute data using a public key of device authentication server 108 and public key infrastructure (PKI).

In step 208 (FIG. 2), device 102 sends the attribute data that was gathered in step 206 to device authentication server 108.

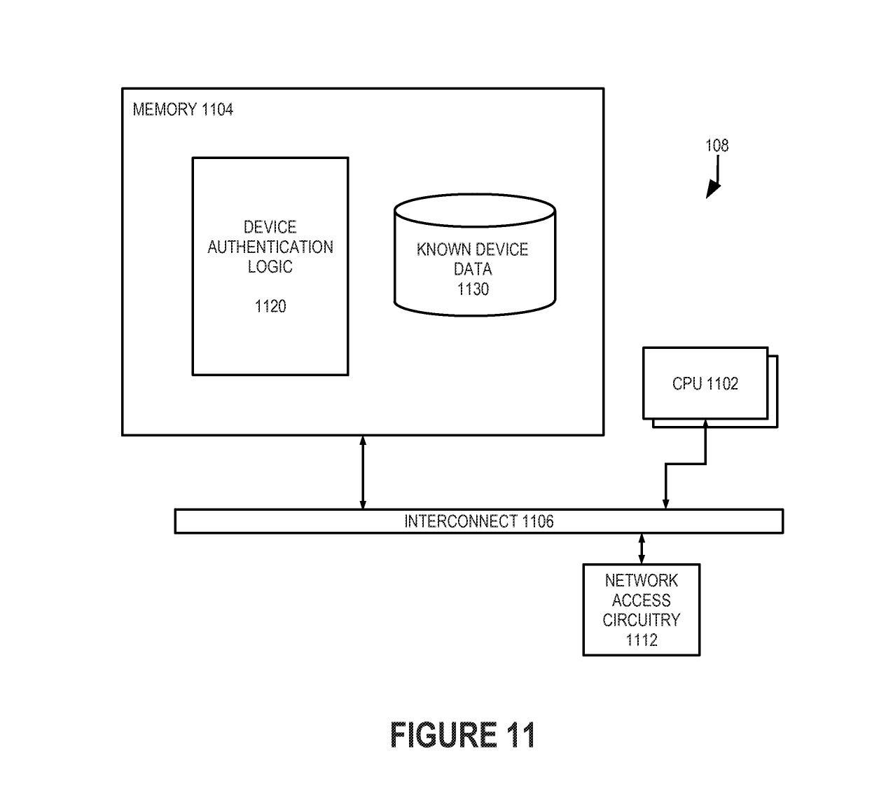

In step 210, device authentication logic 1120 (FIG. 11) of device authentication server 108 creates a device registration record for device 102 from the received attribute data. Device authentication server 108 creates a device registration record in the form of known device record 500 (FIG. 5) for device 102 by creating a globally unique identifier for device 102 as device identifier 502 and storing the values of the respective attributes received in step 208 (FIG. 2) as value 514 (FIG. 5) in respective device attributes 504. Known device record 500 is described more completely below in greater detail.

In step 212 (FIG. 2), device authentication server 108 sends a report of successful registration to device 102. After step 212 (FIG. 2), processing according to transaction flow diagram 200 completes and device 102 is registered for subsequent authentication with device authentication server 108.

In one embodiment, device 102 and the user thereof are considered a single entity to be identified and authenticated. In this embodiment, the device attributes gathered in step 206, received in step 208, and stored in step 210 include interactive device attributes that identify device 102 and its user. In an alternative embodiment, interactive attributes of a given user are registered separately as shown in transaction flow diagram 300 (FIG. 3).

Steps 302, 304, 306, 308, 310, and 312 are analogous to steps 202 (FIGS. 2), 204, 206, 208, 210, and 212, respectively, except as described herein. In step 304 (FIG. 3), the attribute data requested is exclusively interactive attribute date. In step 306, the attribute data retrieved and prepared may be exclusively interactive attribute data. In one implementation, the attribute data may include ancillary physical or environmental data, such as background noise that accompanies a voice recording. In step 310, device authentication logic 1120 (FIG. 11) of device authentication server 108 creates a user registration record for the current user device 102 from the received attribute data.

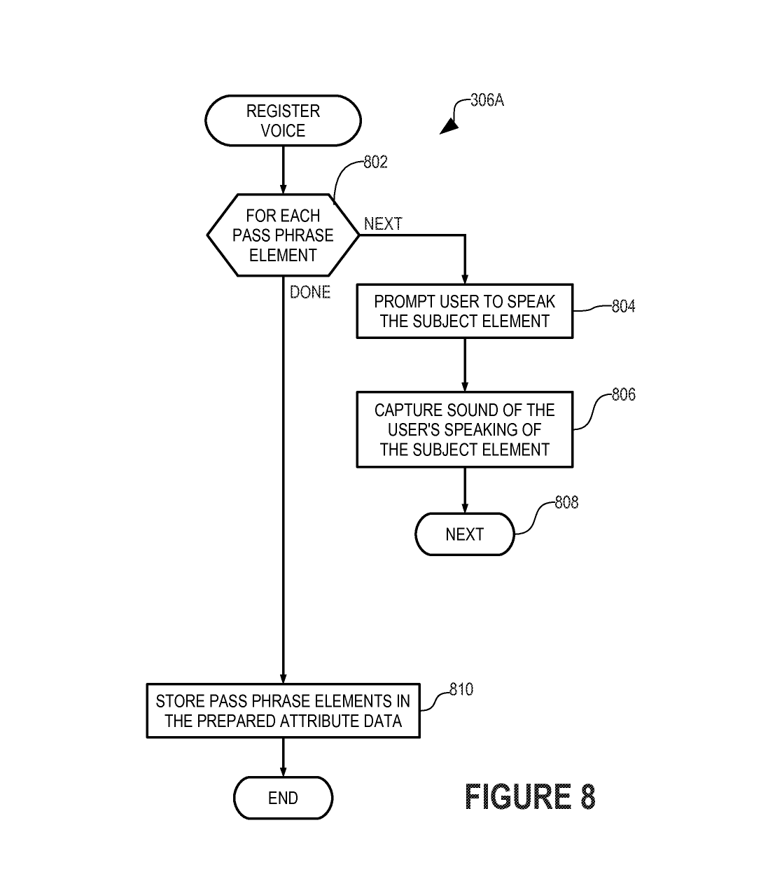

In this illustrative embodiment, the interactive attributes include captured sounds, including the background noise, of the user speaking each of a number of pass phrase elements. This retrieval is illustrated in logic flow diagram 306A (FIG. 8).

Loop step 802 and next step 808 define a loop in which DDK generator 1240 (FIG. 12) processes each element from which disposable pass phrases can be generated according to steps 804-806. While DDK generator 1240 is described as performing the steps of logic flow diagram 206A, it should be appreciated that other logic in device 102, such as web browser plug-in 1222, can perform the steps of logic flow diagram 206A.

The complete set of pass phrase elements to be processed according to the loop of steps 802-808 is predetermined and included in the device attribute request of step 204 (FIG. 2) or 304 (FIG. 3). In one illustrative embodiment, the set of pass phrase elements are words to be spoken by the user. In other embodiments, the set can include speakable symbols such as letters and numerals. Greater security can be provided by having a larger set of pass phrase elements. While such can present a degree of inconvenience to the user, such inconvenience is limited to a one-time registration.

During each iteration of the loop of steps 802-808 (FIG. 8), the particular pass phrase element processed by DDK generator 1240 is sometimes referred to as the subject element. In step 804, DDK generator 1240 prompts the user to speak the subject element. In step 806, DDK generator 1240 captures data representing sound received through a microphone that is one of input devices 1208 (FIG. 12). In some embodiments, steps 804-806 (FIG. 8) are repeated multiple times to get better sampling of the user's voice for improved subsequent matching.

In a more elaborate embodiment that exploits the background noise phenomenon, steps 804 are repeated multiple times for each pass phrase element to provide a more reliable sampling size from which to identify one or more characteristics of background noise that reliably recur with each recording—for example, signals at one or more frequencies that have magnitudes elevated above the noise floor that consistently appear throughout recordings of different pass phrases.

Processing transfers from next step 808 to loop step 802 in which DDK generator 1240 processes the next pass phrase element of the complete set according to steps 804-806. When DDK generator 1240 has processed all pass phrase elements of the complete set according to the loop of steps 802-808, processing by DDK generator 1240 transfers to step 810.

In step 810, DDK generator 1240 stores the captured pass phrase elements in the prepared attribute data to send in step 208 (FIG. 2) or 308 (FIG. 3). In this illustrative embodiment, DDK generator 1240 uses a cryptographic nonce received in step 204 or 304 to obscure the captured sound data.

Known device record 500 (FIG. 5) is a registration record and, in this illustrative example, represents registration of device 102. Known device record 500 includes a device identifier 502 and a number of device attributes 504 which are described briefly above. Each device attribute 504 includes an identifier 506 specifying a particular type of information and a value 514 representing the particular value of that type of information from device 102. For example, if identifier 506 specifies a serial number of a given storage device, value 514 stores the serial number of that storage device within device 102. Similarly, if identifier 506 specifies spoken pass phrase elements of a user of a given storage device, value 514 stores data representing captured sound of the user of device 102 speaking each element that can be used to form a disposable pass phrase. Or, if identifier 506 specifies a background noise characteristic associated with a particular device, value 514 may store data representing a frequency response. This is shown in greater detail in FIG. 6.

Value 514A includes a number of elements 602A, each of which corresponds to a respective element that can be used to produce a disposable pass phrase that the user can be challenged to speak. ID 604A identifies the given element. For example, if elements 602A are all words to be spoken by the user, ID 604A can be a textual representation of a given word. Spoken element 606A is data representing the user's voice speaking the given element. Spoken elements 606A of elements 602A serve as references for voice comparison in identifying and authenticating the user.

Device attribute 504 (FIG. 5) also includes a dimension 508, a behavior 510, an identification class 512, extraction logic 516, comparison logic 518, alert logic 520, and adjustment logic 522. The particular device attribute represented by device attribute 504 is sometimes referred to as “the subject device attribute” in the context of FIG. 5.

Dimension 508 specifies the dimension of the subject attribute. In this illustrative embodiment, there are three (3) dimensions of device attributes: physical, environmental, and interactive.

Behavior 510 specifies the behavior of the subject device attribute, particularly the manner in which the subject device attribute changes over time. In this illustrative embodiment, there are six (6) types of behavior 510: constant, intermittent, variable, variable-progressive, variable-regressive, and variable-requisite. These six types of behavior are described in the “Adaptive Device Authentication” application previously cited.

Identification class 512 specifies a degree to which the subject device attribute identifies a device. In this illustrative embodiment, there are four (4) identification classes: unique, device-common, platform-common, and common. These four (4) identification classes are described in the “Adaptive Device Authentication” application.

Extraction logic 516 specifies the manner in which the subject device attribute is extracted by device 102. Examples of extraction logic 516 are described in “Adaptive Device Authentication”.

Comparison logic 518 specifies the manner in which the subject device attribute is compared to a corresponding device attribute to determine whether device attributes match one another. Examples of comparison logic 518 are described in “Adaptive Device Authentication”.

Alert logic 520 can specify alerts of device matches or mismatches or other events. Examples of alert logic 520 are described in “Adaptive Device Authentication”.

Adjustment logic 522 specifies the manner in which the subject device attribute is to be adjusted after authentication. Examples of adjustment logic 522 are described in “Adaptive Device Authentication”.

Device attribute 504 is shown to include the elements previously described for ease of description and illustration. However, it should be appreciated that a device attribute 504 for a given device can include only identifier 506 and value 514, while a separate device attribute specification can include dimension 508, behavior 510, identification class 512, extraction logic 516, comparison logic 518, alert logic 520, and adjustment logic 522. In addition, all or part of extraction logic 516, comparison logic 518, alert logic 520, and adjustment logic 522 can be common to attributes of a given dimension, behavior type, or identification class and can therefore be defined for the given dimension, behavior type, or identification class. For example, all interactive device attributes that are text to be entered by the user can share the same extraction logic 516 and comparison logic 518, only differing in the text prompt to be displayed to the user and the format of an acceptable answer (e.g., date, numerical, textual).

In addition, it should be appreciated that interactive attributes identify a user of device 102 and not device 102 itself. For simplicity and clarity of explanation, known device record 500 includes both interactive and non-interactive attributes, representing a one-to-one relationship between a user and a device. In some embodiments, interactive attributes can be stored in a known user record and one or more known device records can be associated with the known user record in known device data 1130.

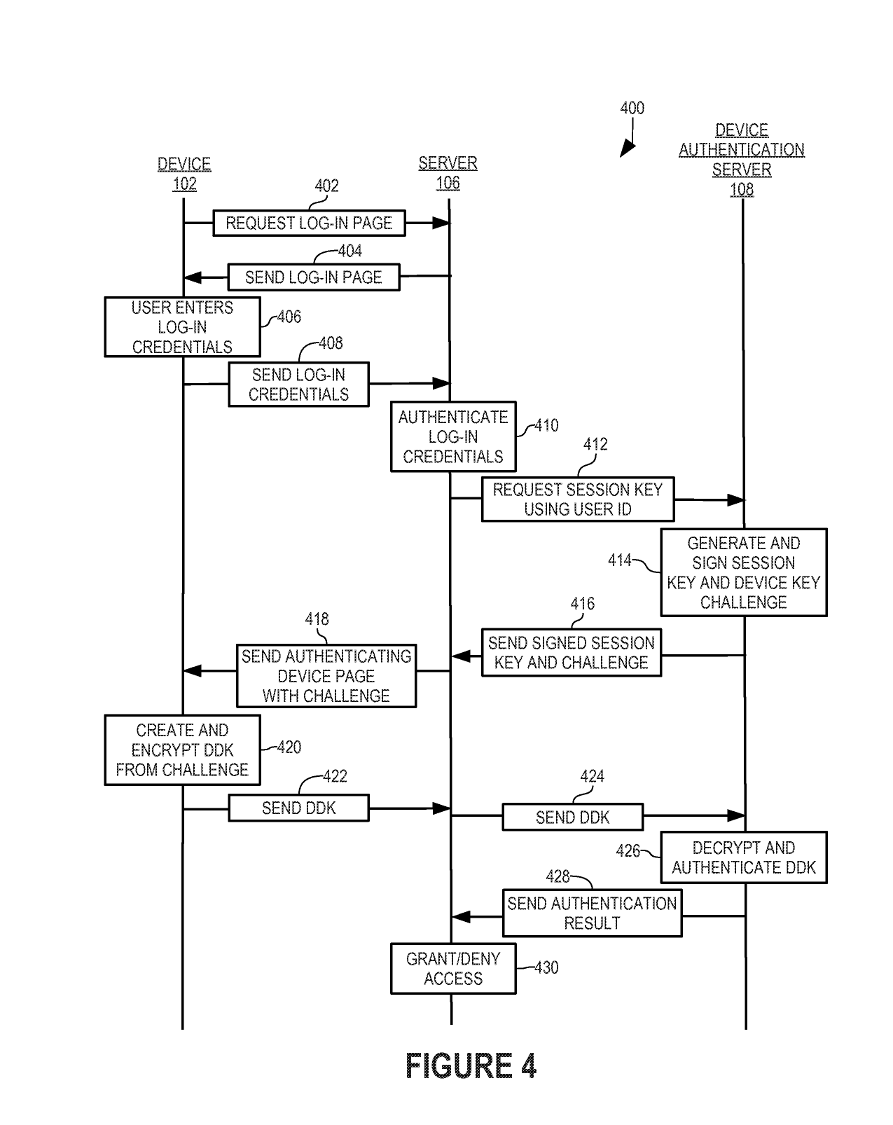

Transaction flow diagram 400 (FIG. 4) illustrates the use of device authentication server 108 to authenticate a user of device 102 and device 102 itself with server 106.

In step 402, device 102 sends a request for a log-in web page to server 106 by which the user can authenticate herself. The request can be in the form of a URL specified by the user of device 102 using web browser 1220 (FIG. 12) and conventional user interface techniques involving physical manipulation of user input devices 1208.

In step 404 (FIG. 4), server 106 sends the web page that is identified by the request received in step 402. The web page sent to device 102 includes content that defines a user interface by which the user of device 102 can enter her authentication credentials, such as a user name and associated password for example.

In step 406, web browser 1220 (FIG. 12) of device 102 executes the user interface and the user of device 102 enters her authentication credentials, e.g., by conventional user interface techniques involving physical manipulation of user input devices 1208.

In step 408 (FIG. 4), device 102 sends the entered authentication credentials to server 106. Server 106 authenticates the authentication credentials in step 410, e.g., by comparison to previously registered credentials of known users. If the credentials are not authenticated, processing according to transaction flow diagram 400 terminates and the user of device 102 is denied access to services provided by server 106. Conversely, if server 106 determines that the received credentials are authentic, processing according to transaction flow diagram 400 continues.

In step 412 (FIG. 4), server 106 sends a request to device authentication server 108 for a session key using a user identifier from the received authentication credentials. In embodiments in which each user has at most one associated device, the user identifier also identifies device 102. In alternative embodiments, the request can include data identifying device 102 as well.

In response to the request, device authentication server 108 generates and cryptographically signs a session key. Session keys and their generation are known and are not described herein. In addition, device authentication server 108 creates a device key challenge and encrypts the device key challenge using a public key of device 102 and PKI. In step 416, device authentication server 108 sends the signed session key and the encrypted device key challenge to server 106.

In step 418, server 106 sends a “device authenticating” page to device 102 along with the device key challenge. The “device authenticating” page includes content that provides a message to the user of device 102 that authentication of device 102 is underway.

The device key challenge causes web browser 1220 (FIG. 12) of device 102 to generate a device identifier, sometimes referred to herein as a dynamic device key (DDK) for device 102, e.g., dynamic device key 1242. In one embodiment, a web browser plug-in 1222 is installed in client device 102 and, invoked by web browser 1220, processes the content of the web page to generate the DDK. In other embodiments, DDK 1242 of device 102 can be generated by other forms of logic of device 102, such as DDK generator 1240, which is a software application installed in device 102.

The device key challenge specifies the manner in which DDK 1242 is to be generated from the attributes of device 102, including interactive attributes, represented in device attributes 504 (FIG. 5). The challenge specifies a randomized sampling of attributes of device 102, allowing the resulting DDK 1242 to change each time device 102 is authenticated. There are a few advantages to having DDK 1242 represent different samplings of the attributes of device 102. One is that any data captured in a prior authentication of device 102 cannot be used to spoof authentication of device 102 using a different device when the challenge has changed. Another is that, since only a small portion of the attributes of device 102 are used for authentication at any time, the full set of attributes of device 102 cannot be determined from one, a few, several, or even many authentications of device 102.

In particular, the device key challenge specifies items of information to be collected from hardware and system configuration attributes of device 102 and the manner in which those items of information are to be combined to form DDK 1242. The generation of a dynamic device key from a device key challenge is described in U.S. Patent Application Publication US 2011/0009092 and in the “Adaptive Device Authentication” application previously cited. Those descriptions are incorporated herein by reference.

In this embodiment, the challenge specifies one or more interactive attributes, requiring attribute data to be provided by the user. At least one of the interactive attributes challenges the user to speak a disposable pass phrase. The disposable pass phrase is a series of elements randomly or pseudo-randomly selected from the elements represented in value 514A (FIG. 6). The challenge can be in the form of a textual prompt displayed to the user in an output device 1210 (FIG. 12) and the user's voice, along with any characteristic background noise, is captured as data through an input device 1208 such as a microphone.

To provide greater security, DDK 1242 includes data representing the user's captured voice obfuscated using a nonce included in the challenge. While use of the disposable pass phrase precludes capture of any single voice response by the user to be used in subsequent authentication, use of the nonce thwarts collection of voice responses over time to recreate enough of value 514A (FIG. 6) to spoof the user's voice in response to a given challenge.

Once DDK 1242 (FIG. 12) is generated according to the received device key challenge, device 102 encrypts DDK 1242 using a public key of device authentication server 108 and PKI.

In step 422 (FIG. 4), device 102 sends the encrypted dynamic device key to server 106, and server 106 sends the encrypted dynamic device key to device authentication server 108 in step 324.

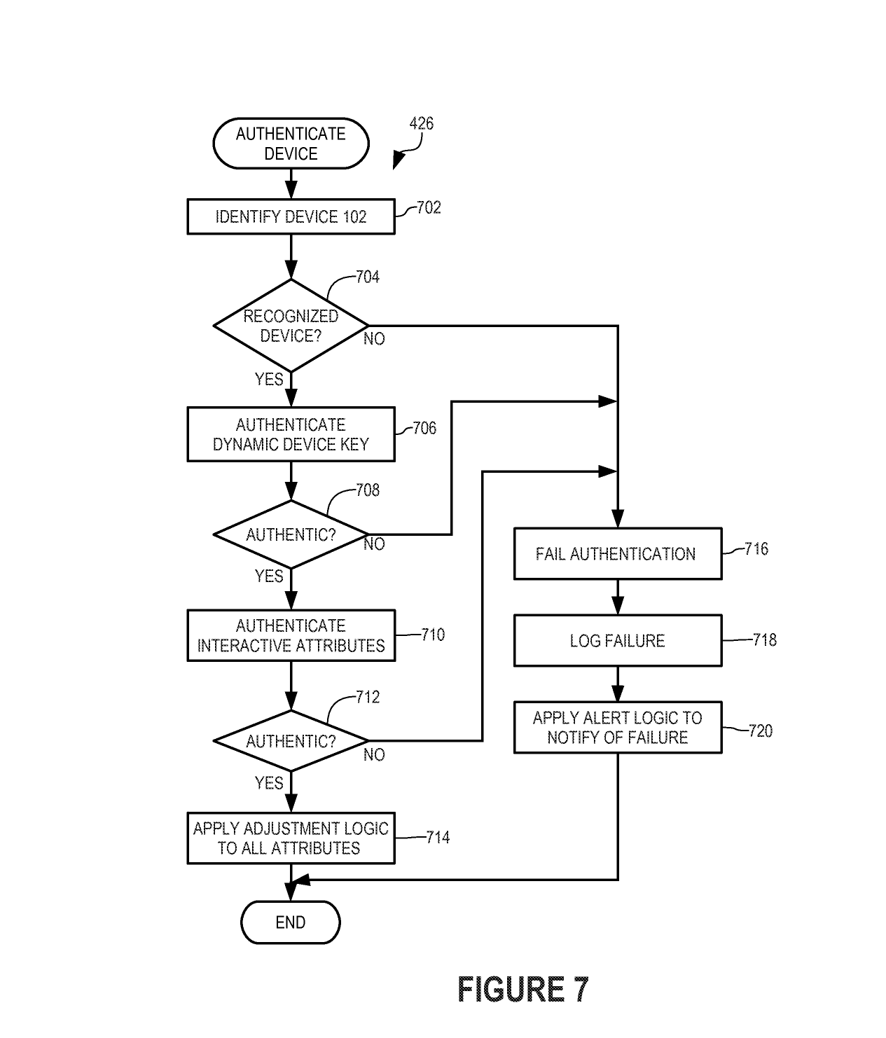

In step 426, device authentication logic 1120 of device authentication server 108 decrypts and authenticates the received DDK. Step 426 is shown in greater detail as logic flow diagram 426 (FIG. 7).

In step 702, device authentication logic 1120 identifies device 102. In this illustrative embodiment, the received DDK includes a device identifier corresponding to device identifier 402 (FIG. 4). Device authentication logic 1120 identifies device 102 by locating a known device record 400 in which device identifier 402 matches the device identifier of the received DDK.

In test step 704 (FIG. 7), device authentication logic 1120 determines whether device 102 is identified. In particular, device authentication logic 1120 determines whether a known device record with a device identifier matching the device identifier of the received DDK is successfully found in known device data 1130. If so, processing transfers to step 706. Otherwise, processing transfers to step 716, which is described below.

In step 706, device authentication logic 1120 authenticates the received DDK using the known device record 400 (FIG. 4) for the identified device, e.g., device 102. Device authentication logic 1120 authenticates by applying the same device key challenge sent in step 418 (FIG. 4) to the known device record 500 that corresponds to the identified device. In this illustrative embodiment, the device key challenge produces a DDK in which a portion of the DDK generated from non-interactive attributes can be parsed from a portion generated from interactive attributes, such that device 102 can be authenticated separately from the user of device 102.

In test step 708 (FIG. 7), device authentication logic 1120 determines whether the received DDK authenticates device 102 by comparing the resulting DDK of step 706 to the received DDK, at least the portion of the DDKs not generated from interactive attributes. In this illustrative embodiment, device authentication logic 1120 uses comparison logic 518 (FIG. 5) for each of the device attributes 504 included in the device key challenge with a dimension 508 that does not indicate an interactive attribute. Examples of comparison logic 518 are described in the “Adaptive Device Authentication” application previously cited.

If the received DDK does not authenticate device 102, processing transfers to step 716 and authentication fails or, alternatively, to step 414 (FIG. 4) in which device authentication logic 1120 sends another device key challenge to re-attempt authentication. If the received DDK authenticates device 102, processing transfers to step 710.

In step 710, device authentication logic 1120 authenticates the portion of the received DDK generated from interactive attributes using the known device record 500 (FIG. 5) for the identified device, e.g., device 102. Device authentication logic 1120 authenticates by applying the same device key challenge sent in step 418 (FIG. 4) to the known device record 500 that corresponds to the identified device.

In test step 712 (FIG. 7), device authentication logic 1120 determines whether the received DDK authenticates the user of device 102 by comparing the resulting DDK of step 706 to the received DDK, at least the portion of the DDKs generated from interactive attributes in the manner described above with respect to non-interactive attributes. Such involves determining whether the voice in which the disposable pass phrase is spoken is that of the user in a manner described below. If the received DDK does not authenticate the user of device 102, processing transfers to step 716 and authentication fails or, alternatively, to step 414 (FIG. 4) in which device authentication logic 1120 sends another device key challenge to re-attempt authentication. If the received DDK authenticates the user of device 102, processing transfers to step 714.

In step 714, device authentication logic 1120 applies adjustment logic to the attributes used to generate the received DDK. In particular, device authentication logic 1120 applies adjustment logic 422 (FIG. 4) of each of device attributes 404 uses to generate the received DDK.

After step 714 (FIG. 7), device 102 and the user of device 102 are successfully authenticated and processing according to logic flow diagram 326, and therefore step 326, completes. As described above, authentication failure at any of test steps 704, 708, and 712 transfers processing to step 716.

In step 716, device authentication logic 1120 determines that device 102 or the user thereof are not authentic, i.e., that authentication according to logic flow diagram 426 fails.

In step 718, device authentication logic 1120 logs the failed authentication and, in step 720, applies alert logic 420 (FIG. 4) to notify various entities of the failed authentication. After step 720 (FIG. 7), processing according to logic flow diagram 326, and therefore step 326, completes.

In step 428 (FIG. 4), device authentication server 108 sends data representing the result of authentication of device 102 to server 106.

In step 430, server 106 determines whether to continue to interact with device 102 and in what manner according to the device authentication results received in step 428.

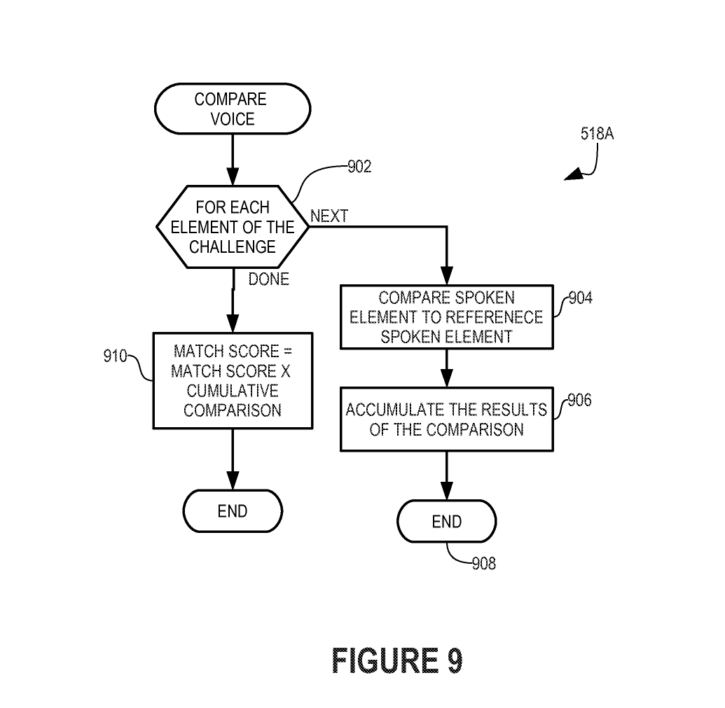

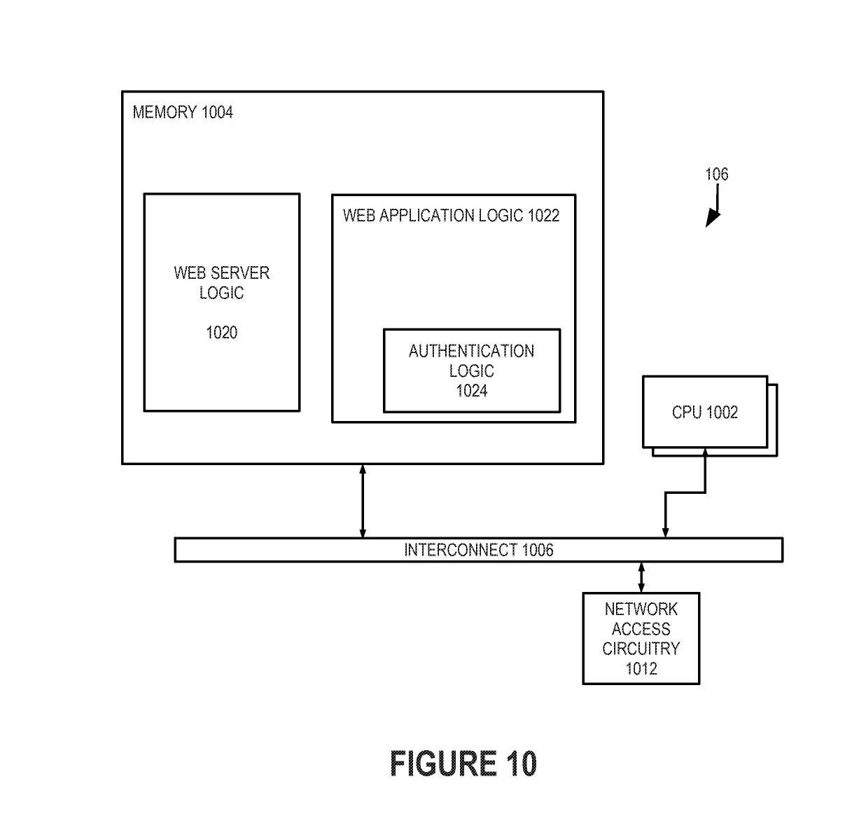

As described above, matches for each attribute are determined according to comparison logic 518 (FIG. 5) for the attribute. In this illustrative example, device authentication logic 1120, in step 710 (FIG. 7), initializes a match score to 1.0 and adjusts the match score as each interactive attribute is compared. An example of comparison logic 518 for the biometric interactive attribute of the user's voice is illustrated in logic flow diagram 518A (FIG. 9).

Loop step 902 and next step 908 define a loop in which device authentication logic 1120 processes each element of the spoken disposable pass phrase according to steps 904-906. During each iteration of the loop of steps 902-908, the particular disposable pass phrase element processed by device authentication logic 1120 is sometimes referred to as “the subject element.”

In step 904, device authentication logic 1120 compares the captured sound of the user speaking the subject element to the corresponding spoken element 606A. The corresponding spoken element 606A (FIG. 6) is determined by the DDK challenge, which includes ID 604A for each of the constituent elements of the disposable pass phrase.

In step 906, device authentication logic 1120 accumulates the results of the comparison of step 904. In this illustrative embodiment, comparison by device authentication logic 1120 in step 904 produces a correlation score in the range of 0.0 to 1.0, in which 1.0 represents a perfect match. In one embodiment, device authentication logic 1120 calculates a mean match score for all comparisons in step 904. In an alternative embodiment, device authentication logic 1120 multiplies a running cumulative comparison by the correlation score determined in step 904. In this alternative embodiment, the cumulative comparison is initialized to 1.0. If the first performance of step 904 produces a correlation score of 0.8, multiplying the cumulative comparison (1.0) by 0.8 produces a new cumulative comparison of 0.8. If the second performance of step 904 also produces a correlation score of 0.8, multiplying the cumulative comparison (0.8) by 0.8 produces a new cumulative comparison of 0.64. The correlation score may also be affected, or adjusted, based on a comparison of known background noise characteristics to background noise captured during the user speaking the subject element to the corresponding spoken element 606A.

Processing by device authentication logic 1120 transfers through next step 908 to loop step 902 in which the next element of the disposable pass phrase is processed according to the loop of steps 902-908. When all elements of the disposable pass phrases have been processed, processing transfers to step 910.

In step 910, device authentication logic 1120 multiplies the cumulative match score by the cumulative comparison. In the alternative embodiment in which the cumulative comparison is the product of all correlation scores, the cumulative comparison can be raised to the power of—n, where n is the number of elements of the disposable pass phrase. Such makes the cumulative comparison independent of the length of the disposable pass phrase.

In an alternative embodiment, device authentication logic 1120 forms a reference audio signal by concatenating spoken elements 606A (FIG. 6) of the constituent elements of the disposable pass phrase in the order the elements are found in the disposable pass phrase to produce a reference audio signal. Device authentication logic 1120 compares the captured audio signal of the user of device 102 to the reference audio signal using conventional voice comparison techniques to produce the match score.

After comparison logic 518 for all attributes of the received DDK have been processed, device authentication logic 1120 compares the cumulative match score to a predetermined threshold. If the cumulative match is at least the predetermined threshold, device authentication logic 1120 determines that device 102 is authentic. Conversely, if the cumulative match score is below the predetermined threshold, device authentication logic 1120 determines that device 102 is not authentic.

Server computer 106 is shown in greater detail in FIG. 12. Server 106 includes one or more microprocessors 1202 (collectively referred to as CPU 1202) that retrieve data and/or instructions from memory 1204 and execute retrieved instructions in a conventional manner. Memory 1204 can include generally any computer-readable medium including, for example, persistent memory such as magnetic and/or optical disks, ROM, and PROM and volatile memory such as RAM.

CPU 1202 and memory 1204 are connected to one another through a conventional interconnect 1206, which is a bus in this illustrative embodiment and which connects CPU 1202 and memory 1204 to network access circuitry 1212. Network access circuitry 1212 sends and receives data through computer networks such as wide area network 104 (FIG. 1).

A number of components of server 106 are stored in memory 1204. In particular, web server logic 1220 and web application logic 1222, including authentication logic 1224, are all or part of one or more computer processes executing within CPU 1202 from memory 1204 in this illustrative embodiment but can also be implemented using digital logic circuitry.

Web server logic 1220 is a conventional web server. Web application logic 1222 is content that defines one or more pages of a web site and is served by web server logic 1220 to client devices such as device 102. Authentication logic 1224 is a part of web application logic 1222 that causes client devices and their users to authenticate themselves in the manner described above.

Device authentication server 108 is shown in greater detail in FIG. 13. Device authentication server 108 includes one or more microprocessors 1102 (collectively referred to as CPU 1102), memory 1104, a conventional interconnect 1106, and network access circuitry 1112, which are directly analogous to CPU 1202 (FIG. 12), memory 1204, conventional interconnect 1206, and network access circuitry 1212, respectively.

A number of components of device authentication server 108 (FIG. 11) are stored in memory 1104. In particular, device authentication logic 1120 is all or part of one or more computer processes executing within CPU 1102 from memory 1104 in this illustrative embodiment but can also be implemented using digital logic circuitry. Known device data 1130 is data stored persistently in memory 1104. In this illustrative embodiment, known device data 1130 is organized as all or part of one or more databases.

Device 102 is a personal computing device and is shown in greater detail in FIG. 14. Device 102 includes one or more microprocessors 1202 (collectively referred to as CPU 1202) that retrieve data and/or instructions from memory 1204 and execute retrieved instructions in a conventional manner. Memory 1204 can include generally any computer-readable medium including, for example, persistent memory such as magnetic and/or optical disks, ROM, and PROM and volatile memory such as RAM.

CPU 1202 and memory 1204 are connected to one another through a conventional interconnect 1206, which is a bus in this illustrative embodiment and which connects CPU 1202 and memory 1204 to one or more input devices 1208, output devices 1210, and network access circuitry 1212. Input devices 1208 can include, for example, a keyboard, a keypad, a touch-sensitive screen, a mouse, a microphone, and one or more cameras. Output devices 1210 can include, for example, a display—such as a liquid crystal display (LCD)—and one or more loudspeakers. Network access circuitry 1212 sends and receives data through computer networks such as wide area network 104 (FIG. 1).

A number of components of device 102 are stored in memory 1204. In particular, web browser 1220 is all or part of one or more computer processes executing within CPU 1202 from memory 1204 in this illustrative embodiment but can also be implemented using digital logic circuitry. As used herein, “logic” refers to (i) logic implemented as computer instructions and/or data within one or more computer processes and/or (ii) logic implemented in electronic circuitry. Web browser plug-ins 1222 are each all or part of one or more computer processes that cooperate with web browser 1220 to augment the behavior of web browser 1220. The manner in which behavior of a web browser is augmented by web browser plug-ins is conventional and known and is not described herein.

Operating system 1230 is all or part of one or more computer processes executing within CPU 1202 from memory 1204 in this illustrative embodiment but can also be implemented using digital logic circuitry. An operating system (OS) is a set of programs that manage computer hardware resources and provide common services for application software such as web browser 1220, web browser plug-ins 1222, and DDK generator 1240.

DDK generator 1240 is all or part of one or more computer processes executing within CPU 1202 from memory 1204 in this illustrative embodiment but can also be implemented using digital logic circuitry. DDK generator 1240 facilitates authentication of device 102 in the manner described above.

Dynamic device key 1242 is data stored persistently in memory 1204 and can be organized as all or part of one or more databases.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for identifying a remotely located device and its user, the method comprising:
receiving device and user identification data from the device, wherein the device and user identification data includes:
a device identifier, wherein the device identifier is a unique identifier of one of a number of known devices;
attribute data, wherein the attribute data represents one or more hardware configuration characteristics of the device; and
interactive attribute data, wherein the interactive attribute data represents one or more characteristics of a user of the device;
determining that the device identifier identifies the device;
determining that the attribute data is consistent with corresponding reference attribute data stored for the device; and
determining that the interactive attribute data is consistent with corresponding reference interactive attribute data stored for the user of the device;
wherein determining that the interactive attribute data is consistent with corresponding reference interactive attribute data stored for the user of the device comprises:
parsing an audio signal from the interactive attribute data, wherein the audio signal includes data representing captured sound of the user speaking a disposable pass phrase;
determining whether the audio signal represents a voice of a recognized user by comparing the audio signal to a control audio signal that represents the disposable pass phrase spoken by the recognized user; and
authenticating the user as the recognized user upon a condition in which determining determines that the audio signal represents a voice of the recognized user.

2. The method of claim 1 wherein determining that the interactive attribute data is consistent with corresponding reference interactive attribute data stored for the device comprises:
determining that the interactive attribute data is not consistent with the corresponding reference interactive attribute data stored for the device; and
in response to determining that the interactive attribute data is not consistent with corresponding reference interactive attribute data stored for the device, requesting new device identification data from the device and, in response to the request, repeating the receiving of device identification data from the device.

3. The method of claim 1 wherein determining that the interactive attribute data is consistent with corresponding reference interactive attribute data stored for the device comprises:
applying predetermined comparison logic associated with the interactive attribute data.

4. The method of claim 1 wherein the device and user identification data is responsive to a device and user identification challenge that includes data identifying a disposable pass phrase that includes one or more elements selected from a collection of two or more pass phrase elements in a randomized manner.

5. The method of claim 1 wherein the audio signal is obscured with a nonce.

6. A non-transitory computer readable medium useful in association with a computer that includes one or more processors and a memory, the computer readable medium including computer instructions that are configured to cause the computer, by execution of the computer instructions in the one or more processors from the memory, to identify a remotely located device and its user by at least:
receiving device and user identification data from the device, wherein the device and user identification data includes:
a device identifier, wherein the device identifier is a unique identifier of one of a number of known devices;
attribute data, wherein the attribute data represents one or more hardware configuration characteristics of the device; and
interactive attribute data, wherein the interactive attribute data represents one or more characteristics of a user of the device;
determining that the device identifier identifies the device;
determining that the attribute data is consistent with corresponding reference attribute data stored for the device; and
determining that the interactive attribute data is consistent with corresponding reference interactive attribute data stored for the user of the device;
wherein determining that the interactive attribute data is consistent with corresponding reference interactive attribute data stored for the user of the device comprises:
parsing an audio signal from the interactive attribute data, wherein the audio signal includes data representing captured sound of the user speaking a disposable pass phrase;
determining whether the audio signal represents a voice of a recognized user by comparing the audio signal to a control audio signal that represents the disposable pass phrase spoken by the recognized user; and
authenticating the user as the recognized user upon a condition in which determining determines that the audio signal represents a voice of the recognized user.

7. The computer readable medium of claim 6 wherein determining that the interactive attribute data is consistent with corresponding reference interactive attribute data stored for the device comprises:
determining that the interactive attribute data is not consistent with the corresponding reference interactive attribute data stored for the device; and
in response to determining that the interactive attribute data is not consistent with corresponding reference interactive attribute data stored for the device, requesting new device identification data from the device and, in response to the request, repeating the receiving of device identification data from the device.

8. The computer readable medium of claim 6 wherein determining that the interactive attribute data is consistent with corresponding reference interactive attribute data stored for the device comprises:
applying predetermined comparison logic associated with the interactive attribute data.

9. The computer readable medium of claim 6 wherein the device and user identification data is responsive to a device and user identification challenge that includes data identifying a disposable pass phrase that includes one or more elements selected from a collection of two or more pass phrase elements in a randomized manner.

10. The computer readable medium of claim 6 wherein the audio signal is obscured with a nonce.

11. A computer system comprising:
at least one processor;
a computer readable medium that is operatively coupled to the processor;
network access circuitry that is operatively coupled to the processor; and
device and user identification logic (i) that executes at least in part in the processor from the computer readable medium and (ii) that, when executed, causes the processor to identify a remotely located device and its user by at least:
receiving device and user identification data from the device, wherein the device and user identification data includes:
a device identifier, wherein the device identifier is a unique identifier of one of a number of known devices;
attribute data, wherein the attribute data represents one or more hardware configuration characteristics of the device; and
interactive attribute data, wherein the interactive attribute data represents one or more characteristics of a user of the device;
determining that the device identifier identifies the device;
determining that the attribute data is consistent with corresponding reference attribute data stored for the device; and
determining that the interactive attribute data is consistent with corresponding reference interactive attribute data stored for the user of the device;
wherein determining that the interactive attribute data is consistent with corresponding reference interactive attribute data stored for the user of the device comprises:
parsing an audio signal from the interactive attribute data, wherein the audio signal includes data representing captured sound of the user speaking a disposable pass phrase;
determining whether the audio signal represents a voice of a recognized user by comparing the audio signal to a control audio signal that represents the disposable pass phrase spoken by the recognized user; and
authenticating the user as the recognized user upon a condition in which determining determines that the audio signal represents a voice of the recognized user.

12. The computer system of claim 11 wherein determining that the interactive attribute data is consistent with corresponding reference interactive attribute data stored for the device comprises:
determining that the interactive attribute data is not consistent with the corresponding reference interactive attribute data stored for the device; and
in response to determining that the interactive attribute data is not consistent with corresponding reference interactive attribute data stored for the device, requesting new device identification data from the device and, in response to the request, repeating the receiving of device identification data from the device.

13. The computer system of claim 11 wherein determining that the interactive attribute data is consistent with corresponding reference interactive attribute data stored for the device comprises:
applying predetermined comparison logic associated with the interactive attribute data.

14. The computer system of claim 11 wherein the device and user identification data is responsive to a device and user identification challenge that includes data identifying a disposable pass phrase that includes one or more elements selected from a collection of two or more pass phrase elements in a randomized manner.

15. The computer system of claim 11 wherein the audio signal is obscured with a nonce.
